(19) United States
(12) Patent Application Publication
(10) Pub. No.: US 2014/0193751 A1
(43) Pub. Date: Jul. 10, 2014

(54) TONER SET, IMAGE FORMING APPARATUS, AND IMAGE FORMING METHOD

(71) Applicant: FUJI XEROX CO., LTD., Tokyo (JP)

(72) Inventors: Atsushi SUGITATE, Kanagawa (JP); Masaru TAKAHASHI, Kanagawa (JP); Shotaro TAKAHASHI, Kanagawa (JP); Sakiko HIRAI, Kanagawa (JP); Shuji SATO, Kanagawa (JP)

(21) Appl. No.: 13/944,416

(22) Filed: Jul. 17, 2013

(30) Foreign Application Priority Data
Jan. 9, 2013 (JP) 2013-001855

(51) Int. Cl. G03G 9/09; G03G 13/22

(52) U.S. Cl. CPC G03G 9/0902; G03G 13/22
USPC 430/107.1; 430/123.57; 399/298

(57) ABSTRACT

Provided is a toner set including a brilliant toner containing a brilliant pigment and at least one kind of color toner containing a colorant, in which a ratio (G′ A/G′B) of G′A to G′B satisfies a relationship of 1≦G′A/G′B≦10, when a storage modulus in 120° C. of the brilliant toner is G′A and a storage modulus in 120° C. of the color toner is G′B.

### CROSS-REFERENCE TO RELATED APPLICATIONS

This application is based on and claims priority under 35 USC 119 from Japanese Patent Application No. 2013-001855 filed Jan. 9, 2013.

### BACKGROUND

1. Technical Field

The present invention relates to a toner set, an image forming apparatus, and an image forming method.

2. Related Art

For the purpose of forming an image having brightness like metallic luster, a brilliant toner is used.

### SUMMARY

According to an aspect of the invention, there is provided a toner set including a brilliant toner containing a brilliant pigment and at least one kind of color toner containing a colorant, in which a ratio (G′A/G′B) of G′A to G′B satisfies a relationship of 1≦G′A/G′B≦10, when a storage modulus in 120° C. of the brilliant toner is G′A and a storage modulus in 120° C. of the color toner is G′B.

### BRIEF DESCRIPTION OF THE DRAWINGS

Exemplary embodiments of the present invention will be described in detail based on the following figures, wherein:

FIGS. 1A to 1E are views illustrating an example of a process of forming a brilliant color image by electrophotography;

FIG. 2 is a cross-sectional view schematically illustrating an example of a brilliant toner particle according to an exemplary embodiment; and

FIG. 3 is a schematic configuration diagram illustrating an example of an image forming apparatus according to an exemplary embodiment.

### DETAILED DESCRIPTION

Hereinafter, a toner set, an image forming apparatus, and an image forming method according to exemplary embodiments of the invention will be described in detail.

Toner Set

A toner set according to an exemplary embodiment includes a brilliant toner containing a brilliant pigment and at least one kind of color toner containing a colorant, in which a ratio (G′A/G′B) of G′A to G′B satisfies a relationship of 1≦G′A/G′B≦10, when a storage modulus in 120° C. of the brilliant toner is G′A and a storage modulus in 120° C. of the color toner is G′B.

In the exemplary embodiment, two or more kinds of color toner, whose colors may be different from each color, may be used as the color toner. In such a case that storage moduli G′B of respective color toners are different when two or more kinds of color toner are used, G′B becomes the maximum values of plural color toners other than black color.

According to the present exemplary embodiments, a fixing temperature of toner image (a heating temperature of fixing unit such as a fixing roll) is approximately 140° C., and the actual heating temperature is approximately 120° C. when the toner image is fixed, and accordingly, the relationship between storage moduli in 120° C. of the brilliant toner and the color toner is regulated. The melting of brilliant toner and color toner when the toner image is fixed is adjusted by regulating the relationship between storage moduli in 120° C. of the brilliant toner and the color toner.

When the toner set according, to the exemplary embodiment is used, an excellent tone of image without damaging brilliance is formed.

A brilliant toner containing flake-shape brilliant pigment in the toner is known in the related art. When a brilliant color image is formed using the brilliant toner containing flake-shape brilliant pigment and color toner, it is preferable that brilliant pigment is provided so as to be oriented with respect to a paper (recording medium) as the lowest layer of toner image, in order to obtain high brilliance.

In the related art, even if the brilliant pigment concentration of the brilliant toner is low and only the brilliant toner is used, brilliance may be obtained. However, the case in which the brilliance decreases when color toner is superimposed onto the brilliant toner, may occur. When the brilliant pigment concentration of brilliant toner is increased, in order to obtain high brilliance in the state of superimposing color toner onto the brilliant toner, toner viscoelasticity of brilliant toner increases due to filler effect of brilliant pigment. As a result, an image is formed in the state in which brilliant pigment is not oriented with respect to the paper, and therefore not only the brilliance decreases but also tone of the image deteriorates in some cases.

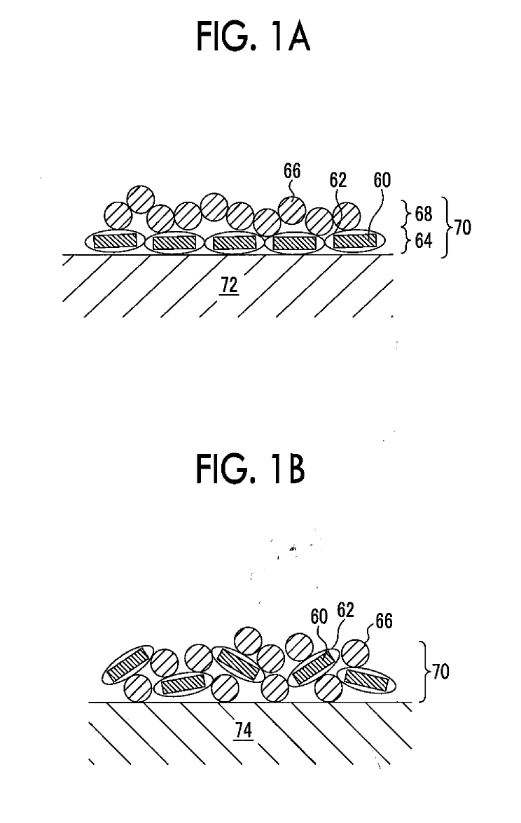

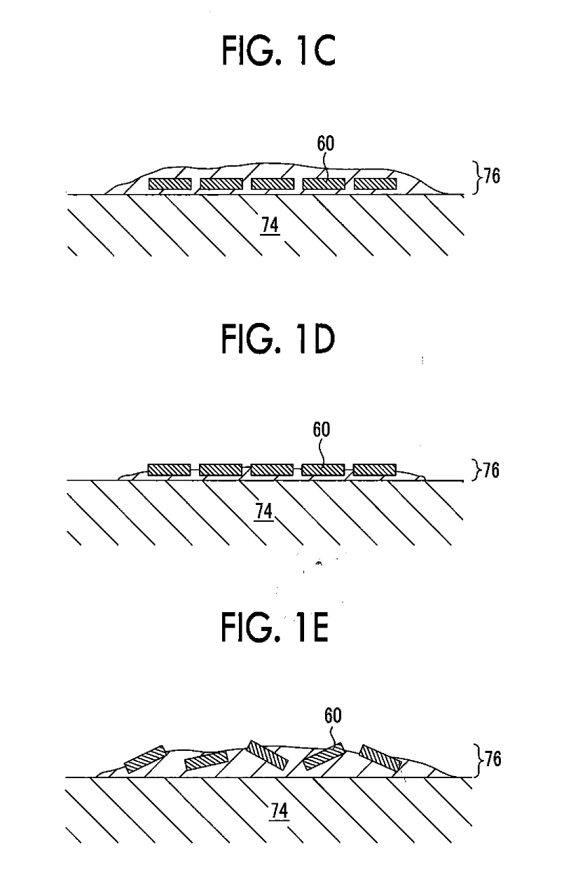

FIGS. 1A to 1E show an example of a forming process of a color image with brilliance by electrophotography. In FIG. 1A, a silver toner image 64 formed by a silver toner 62 that contains a flake-shape pigment (brilliant pigment) 60 and exhibits brilliance and a color image 68 formed by a color toner 66 are superimposed and thus a superimposed toner image 70 is formed on an intermediate transfer body 72. The color toner 66 of cyan, magenta, yellow, black or the like is considered to be in a spherical shape compared to the brilliant toner but a silver toner is considered to be in a flake shape. This is because a flake-shape pigment (such as aluminum) is used as the brilliant pigment 60.

As shown in FIG. 1A, in order to cancel out the charge of toner particles to the maximum extent, it is assumed that the flake-shape silver toner 62 is adhered to the intermediate transfer body 72 such that the adhering area becomes the maximum. As a result, the brilliant pigment 60 is oriented with respect to the surface of the intermediate transfer body 72 and is more easily present in such a manner that the long axis thereof is relatively parallel.

Subsequently, as shown in FIG. 1B, the superimposed toner image 70 formed on the intermediate transfer body 72 is transferred onto a recording medium 74 through a transferring process. In the superimposed toner image 70 transferred onto the recording medium 74, the color toner 66 is interposed between the silver toner 62 and the recording medium 74 and this causes the disarray in the orientation of the brilliant pigment 60. That is, there may be a case where the direction of the long axis of the brilliant pigment 60 included in the silver toner 62 is disarrayed with respect to the surface of the recording medium 74.

There is a case where by pressurizing and heating the superimposed toner image 70 in a state where the orientation of the brilliant pigment 60 is disarrayed, the superimposed toner image 70 is fixed onto the recording medium 74, and a fixed toner image 76 is formed. At this time, the orientation of the brilliant pigment 60 with respect to the recording medium 74 is influenced depending on the relationship in size between storage modulus G′A in 120° C. of the brilliant toner 62 and storage modulus G′B in 120° C. of the color toner 66. As shown in FIG. 1C, it is preferable that the brilliant pigment 60 is fixed in a state where the surface thereof is covered in the fixed toner image 76 and the brilliant pigment 60 is dispersed to be oriented with respect to the surface of the recording medium 74. It is clearly found that the fixed toner image shown in FIG. 1C is obtained when a ratio (G′A/G′B) of G′A to G′B satisfies the relationship of 1≦G′A/G′B≦10, based on the result of intensive study by the inventor of the present exemplary embodiments or the like. The reason is not clear but is assumed to be as follows. The ratio (G′A/G′E) satisfies the relationship of 1≦G′A/G′B≦10, and therefore the melting viscosity of the color toner becomes low and the brilliant pigment in the brilliant toner is easily arranged again. As a result, it is assumed to improve the tone of the image.

On the other hand, when the ratio (G′A/G′B) exceeds 10, the color toner image 68 is melted too much when the superimposed toner image 70 is fixed on the recording medium 74. Therefore, the brilliant pigment 60 is exposed from the surface of the fixed toner image 76, and the tone of the fixed toner image 76 is lost in some cases, as shown in FIG. 1D.

When the ratio (G′A/G′B) is less than 1, the color toner image 68 is hardly to be melted when the superimposed toner image 70 is fixed on the recording medium 74. As shown in FIG. 1E, the brilliance from the fixed toner image 76 is lost due to the generated diffused reflection since the brilliant pigment 60 is fixed in a state where the long axis thereof is disarrayed with respect to the surface of the recording medium 74. Additionally, image intensity deteriorates in some cases.

The term “brilliance” in the exemplary embodiment indicates that an image has brightness similar to metallic luster when the image formed by the toner according to the exemplary embodiment is visually checked.

The toner set in the exemplary embodiments includes a brilliant toner containing a brilliant pigment and at least one kind of color toner containing a colorant. The combination thereof is not limited so far as the relationship between storage modulus G′ A in 120° C. of the brilliant toner and storage modulus G′B in 120° C. of the color toner other than black color satisfies the predetermined value.

Examples of color toner which may be contained in the toner set according to the exemplary embodiment include a well-known toner of the related art such as a magenta toner, a cyan toner, a yellow toner, a black toner, a red toner, a green toner, a blue toner, an orange toner, and a violet toner, and it is preferable that color toner showing the maximum value of G′B of plural color toners includes the yellow pigment. Generally, the yellow pigment has weaker coloring characteristic in comparison with pigments of other colors, and it is necessary to increase the addition amount. As a result, pigments are easily served as a filler, and the control of G′B tends to be difficult. Therefore, the viscoelastic control of other color toner is also easily controlled when it is possible to control the toner including the yellow pigment. At this time, the black color is excluded since light hardly penetrates the black color. In this case, the need of regulating storage modulus G′B with respect to brilliance becomes low.

Hereinafter, the brilliant toner according to the exemplary embodiment forming the toner set according to the exemplary embodiment will be described.

In the brilliant toner of the exemplary embodiment, when a solid image is formed, a ratio (A/B) of a reflectance A at a light receiving angle of +30° to a reflectance B at a light receiving angle of −30°, which are measured when the image is irradiated with incident light at an incident angle of −45° using a variable angle photometer, is preferable from 2 to 100.

If the ratio (A/B) is equal to or greater than 2, this indicates that light is reflected more toward a side (“angle+” side) opposite to the light incident side than toward a side (“angle−” side) where the incident light enters, that is, this indicates that diffuse reflection of the incident light is inhibited. When the diffuse reflection in which the incident light is reflected to various directions is caused, if the reflected light is visually checked, colors look blurry. Therefore, when the ratio (A/B) is less than 2, even if the reflected light is visually checked, gloss is not confirmed, thereby causing inferior brilliance in some cases.

On the other hand, when the ratio (A/B) exceeds 100, a viewing angle in which the reflected light may be visually checked is narrowed too much, and specular reflected light components are large. Therefore, a phenomenon in which colors look darkish depending on angles may occur. In addition, it is also difficult to prepare a brilliant toner in which the ratio (A/B) exceeds 100.

The ratio (A/B) is preferable from 50 to 100, more preferably from 60 to 90, and particularly preferably from 70 to 80.

Measurement of Ratio (A/B) Using Variable angle Photometer

First, an incident angle and a light receiving angle will be described. In the exemplary embodiment, when the measurement is performed using a variable angle photometer, the incident angle is set to −45°. This is because the sensitivity of the measurement is high with respect to images of a wide range of gloss level.

In addition, the reason why the light receiving angle is set to −30° and +30° is that the sensitivity of the measurement is the highest for evaluating images having and not having the impression of brilliance.

Next, the method of measuring the ratio (A/B) will be described.

In the exemplary embodiment, when the ratio (A/B) is measured, first, a “solid image” is formed in the following manner. A developer as a sample is filled in a developer unit of a DocuCentre-III C7600 manufactured by Fuji Xerox Co., Ltd., and a solid image in which an amount of toner applied is 4.5 g/cm² is formed on a sheet of recording paper (OK Topcoat+ Paper manufactured by Oji Paper Co., Ltd.) at a fixing temperature of 190° C. and at a fixing pressure of 4.0 kg/cm². The “solid image” refers to an image of 100% printing rate.

Using a goniospectrocolorimeter GC5000L manufactured by NIPPON DENSHOKU INDUSTRIES CO., LTD. as a variable angle photometer, incident light that enters the solid image at an incident angle of −45° is applied to the image portion of the formed solid image, and the reflectance A at a light receiving angle of +30° and the reflectance B at a. light receiving angle of −30° are measured. The reflectances A and B are measured with respect to light having a wavelength ranging from 400 nm to 700 nm at an interval of 20 nm, and the average value of the reflectance at each wavelength is used as the reflectances A and B. The ratio (A/B) is calculated from the measurement results.

Configuration of Brilliant Toner

From the viewpoint of satisfying the ratio (A/B) described above, the brilliant toner according to the exemplary embodiment may preferably meet the requirements (1) and (2) below.

(1) The brilliant toner has an average equivalent circle diameter D larger than an average maximum thickness C.

(2) When a cross section of the brilliant toner in a thickness direction thereof is observed, the number of pigment particles arranged so that an angle formed by a long axis direction of the brilliant toner in the cross section and a long axis direction of a pigment particle is in a range of −30° to +30° is equal to or greater than 60% of the total number of the observed pigment particles.

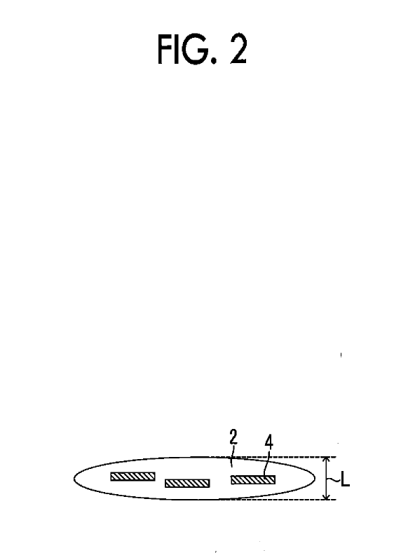

Herein, FIG. 2 is a cross-sectional view schematically illustrating the toner (brilliant toiler) which satisfies the requirements (1) and (2) described above. In addition, the schematic view shown in FIG. 2 is a cross-sectional view of the brilliant toner in a thickness direction thereof.

A brilliant toner 2 shown in FIG. 2 is a flake-shape toner having an equivalent circle diameter larger than a thickness L and contains a flake-shape pigment particle 4 (corresponding to a brilliant pigment).

As shown in FIG. 2, in a case where the brilliant toner 2 has a flake shape having an equivalent circle diameter larger than a thickness L, when the brilliant toner is moved to an image holding member, an intermediate transfer body, a recording medium, or the like in a step of development or a step of transferring in image formation, the brilliant toner tends to move so as to cancel out the charge of the brilliant toner to the maximum extent. Therefore, it is considered that the brilliant toner is arranged such that the adhering area becomes the maximum. That is to say, it is considered that the flake-shape brilliant toner is arranged such that the flat surface side of the brilliant toner faces a surface of a recording medium onto which the brilliant toner is finally transferred. Moreover, in a step of fixing in image formation, it is considered that the flake-shape brilliant toner is also arranged by the pressure during fixing such that the flat surface side of the brilliant toner faces the surface of the recording medium.

Accordingly, among the flake-shape pigment particles contained in the brilliant toner, pigment particles that satisfy the requirement “an angle formed by a long axis direction of the brilliant toner in the cross section and a long axis direction of a pigment particle is in a range of −30° to +30°” described in (2) above are considered to be arranged such that the surface side, which provides the maximum area, faces the surface of the recording medium. When an image formed in this manner is irradiated with light, it is considered that the proportion of pigment particles, which cause diffuse reflection of incident light, is reduced and thus the above-described range of the ratio (A/B) may be achieved. Further, if the proportion of pigment particles, which cause diffuse reflection of incident light, is reduced, the reflected light intensity varies greatly depending on viewing angles, thereby obtaining more ideal brilliance.

Next, the components constituting the brilliant toner according to the exemplary embodiment will be described.

Brilliant Pigment

Examples of the brilliant pigments used in the exemplary embodiment include the following: powders of metals such as aluminum, brass, bronze, nickel, stainless steel and zinc; flaky inorganic crystal substrates coated with a thin layer, such as, mica, barium sulfate, a layer silicate, and a silicates of layer aluminum which are coated with titanium oxide or yellow iron oxide; single-crystal plate-like titanium oxide; basic carbonate; bismuth oxychloride; natural guanine; flaky glass particles; and metal-deposited flaky glass particles. The brilliant pigments used in the exemplary embodiment are not particularly limited as long as the brilliant pigments have brilliance.

The content of the brilliant pigment in the brilliant toner according to the exemplary embodiment is preferably from 4% by weight to 55% by weight, with respect to binder resin described later. When the content of the brilliant pigment is less than 4% by weight, brilliance may be deteriorated in some cases. When the content of the brilliant pigment exceeds 55% by weight, the smoothness of the fixed image is deteriorated. As a result, brilliance may be deteriorated in some cases.

Binder Resin

The brilliant toner according to the exemplary embodiment may contain binder resin.

Examples of the binder resin which is used in the exemplary embodiment include ethylene resins such as polyester, polyethylene and polypropylene; styrene resins such as polystyrene and α-polymethylstyrene; (meth) acrylic resins such as polymethyl methacrylate and polyacrylonitrile; polyamide resins; polycarbonate resins; polyether resins; and copolymer resins thereof. Among these resins, polyester resins are preferably used from the viewpoint of high smoothness on a surface of a fixed image and superior brilliance.

Hereinafter, polyester resins that are particularly preferably used will be described.

The polyester resins according to the exemplary embodiment may be those obtained mainly by, for example, polycondensation of a polyvalent carboxylic acid and a polyol.

Examples of the polyvalent carboxylic acid include aromatic carboxylic acids such as terephthalic acid, isophthalic acid, phthalic anhydride, trimellitic anhydride, pyromellitic acid, and naphthalenedicarboxylic acid; aliphatic carboxylic acids such as maleic anhydride, fumaric acid, succinic acid, alkenyl succinic anhydride, and adipic acid; and alicyclic carboxylic acids such as cyclohexanedicarboxylic acid. These polyvalent carboxylic acids are used alone or in combination of two or more kinds thereof.

Among these polyvalent carboxylic acids, the aromatic carboxylic acids are preferably used. Furthermore, in order to obtain a favorable fixing property and to form a cross-linked structure or a branched structure, a trivalent or higher carboxylic acid (such as trimellitic acid or an acid anhydride thereof) is preferably used in combination with a dicarboxylic acid.

Examples of the polyol include aliphatic diols such as ethylene glycol, diethylene glycol, triethylene glycol, propylene glycol, butanediol, hexanediol, neopentyl glycol, and glycerin; alicyclic diols such as cyclohexanediol, cyclohexanedimethanol, and hydrogenated bisphenol A; and aromatic diols such as ethylene oxide adducts of bisphenol A and propylene oxide adducts of bisphenol A. These polyols are used alone or in combination of two or more kinds thereof.

Among these polyols, aromatic diols and alicyclic diols are preferable. Among these, aromatic diols are more preferable. Furthermore, in order to obtain a more favorable fixing property and to form a cross-linked structure or a branched structure, a trivalent or higher valent polyol (such as glycerin, trimethylolpropane, or pentaerythritol) may also be used in combination with a dial.

A glass transition temperature (Tg) of binder resin is preferably in a range of from 50° C. to 80° C. When Tg is lower than 50° C., the problem may occur in storage stability of toner and storage stability of the fixed image. Additionally, when Tg is higher than 80° C., there is such a case that fixation of the image in low temperature is not possible in comparison with the related art.

Tg of binder resin is more preferably from 50° C. to 65° C.

Furthermore, the glass transition temperature of binder resin is found as the peak temperature of endothermic peak which is obtained by differential scanning calorimetry (DSC)

Molecular weight determination of binder resin is carried out by gel permeation chromatography (GPC) method of tetrahydrofuran (THF) soluble element. Weight average molecular weight (Mw) is preferably from 5000 to 1000000, and more preferably from 7000 to 500000, and number average molecular weight (Mn) is preferably from 2000 to 100000. The distribution of molecular weight Mw/Mn is preferably from 1.5 to 100, and more preferably from 2 to 60.

Method of Preparing Polyester Resin

A method of preparing a polyester resin is not particularly limited, and the polyester resin is prepared by a normal polyester polymerization method in which an acid component is reacted with an alcohol component. For example, the polyester resin is prepared by properly employing a direct polycondensation method, an ester interchange method, or the like depending on the types of monomers used. The molar ratio (acid component/alcohol component) in the reaction between the acid component and the alcohol component is different depending on the reaction conditions and the like. However, in order to obtain a high molecular weight, the molar ratio is preferably about 1/1 in general.

Examples of catalysts usable for preparing the polyester resin include alkali metal compounds such as sodium or lithium; compounds of an alkaline earth metal such as magnesium or calcium; compounds of a metal such as zinc, manganese, antimony, titanium, tin, zirconium, or germanium; phosphorous acid compounds; phosphoric acid compounds; and amine compounds.

Release Agent

The brilliant toner according to the exemplary embodiment may contain a release agent.

Examples of the release agent which is used in the exemplary embodiment include paraffin wax such as low-molecular weight polypropylene and low-molecular weight polyethylene; silicone resins; rosins; rice wax; and carnauba wax. The melting temperature of the release agent is preferably from 50° C. to 100° C., and more preferably from 60° C. to 95° C.

The content of the release agent in the brilliant toner is preferably from 0.5% by weight to 15% by weight, and more preferably from 1.0% by weight to 12% by weight.

Other Additives

Besides the components described above, other components such as an internal additive, a charge control agent, an inorganic powder (inorganic particles), and organic particles may also be used in the exemplary embodiment, as necessary.

Examples of the charge control agent include quaternary ammonium salt compounds, nigrosine compounds, dyes containing a complex of aluminum, iron, chromium or the like, and triphenylmethane pigments.

Examples of the inorganic particles include known inorganic particles such as silica particles, titanium oxide particles, alumina particles, cerium oxide particles, and particles obtained by hydrophobizing the surfaces of these particles. These inorganic particles may be used alone or in combinations of two or more kinds thereof. Among these inorganic particles, silica particles, which have a refractive index lower than that of the above-described binder resin, are preferably used. The silica particles may be subjected to various surface treatments. For example, silica particles surface-treated with a silane coupling agent, a titanium coupling agent, silicone oil, or the like are preferably used.

Characteristics of Brilliant Toner

Average Maximum Thickness C and Average Equivalent-Circle Diameter D

As described in (1) above, the brilliant toner according to the exemplary embodiment preferably has the average equivalent-circle diameter D larger than the average maximum thickness C thereof. Moreover, the ratio (C/D) of the average maximum thickness C to the average equivalent-circle diameter D is more preferably in the range of from 0.001 to 0.500, further preferably in the range of from 0.010 to 0.200, and particularly preferably in the range of from 0.050 to 0.100.

When the ratio (C/D) is 0.001 or more, the strength of the brilliant toner may be ensured, and breakage of the toner due to a stress during image formation may be suppressed. Thus, a decrease in charges, the decrease being caused by exposure of the pigment, and fogging caused as a result thereof may be suppressed. On the other hand, when the ratio (C/D) is 0.500 or less, a good brilliance may be obtained.

The average maximum thickness C and the average equivalent-circle diameter D are measured by the methods below.

Brilliant toner particles are placed on a smooth surface and uniformly dispersed by applying vibrations. One thousand brilliant toner particles are observed with a color laser microscope “VK-9700” (manufactured by Keyence Corporation) at a magnification of 1,000 times to measure the maximum thickness C and the equivalent-circle diameter D of a surface viewed from the top, and the arithmetic averages thereof are calculated to determine the average maximum thickness C and the average equivalent-circle diameter D.

Angle Formed by Long Axis Direction of Brilliant Toner in Cross Section and Long Axis Direction of Pigment Particles

As described in (2) above, when a cross section of the brilliant toner in the thickness direction thereof is observed, the number of pigment particles arranged so that an angle formed by a long axis direction of the brilliant toner in the cross section and a long axis direction of a pigment particle is in the range of −30° to +30° is preferably 60% or more of the total number of the observed pigment particles. Furthermore, the number is more preferably from 70% to 95%, and particularly preferably from 80% to 90%.

When the above number is 60% or more, a good brilliance may be obtained.

Herein, a method of observing a cross section of the brilliant toner will be described.

Brilliant toner particles are embedded in a mixture of a bisphenol A-type liquid epoxy resin and a curing agent, and a sample for cutting is then prepared. Next, the sample for cutting is cut at −100° C. using a cutting machine with a diamond knife (a LEICA Ultramicrotome (manufactured by Hitachi Technologies Corporation) is used in the exemplary embodiment) to prepare a sample for observation. The obtained sample is observed with a transmission electron microscope (TEM) at a magnification of about 5,000 times to observe cross sections of the brilliant toner particles. For observed 1,000 brilliant toner particles, the number of pigment particles arranged so that the angle formed by the long axis direction of a brilliant toner in the cross section and the long axis direction of a pigment particle is in the range of −30° to +30° is counted using image analysis software, and the proportion thereof is calculated.

The term “long axis direction of a brilliant toner in the cross section” refers to a direction orthogonal to a thickness direction of the brilliant toner having an average equivalent-circle diameter D larger than the average maximum thickness C, and the term “long axis direction of a pigment particle” refers to a length direction of the pigment particle.

The volume average particle diameter of the brilliant toner according to the exemplary embodiment is preferably from 1 μm to 30 μm, more preferably from 3 μM to 20 μm, and further preferably from 5 μm to 10 μm.

The volume average particle diameter D₅₀ᵥ is determined as follows. A cumulative volume distribution curve and a cumulative number distribution curve are drawn from the smaller particle diameter end, respectively, for each particle diameter range (channel) divided on the basis of a particle diameter distribution measured with a measuring instrument such as a Multisizer II (manufactured by Beckman Coulter Inc.). The particle diameter providing 16% accumulation is defined as that corresponding to volume D₁₆ᵥ and number D₁₆ₚ, the particle diameter providing 50% accumulation is defined as that corresponding to volume D₅₀ᵥ and number D₅₀ₚ, and the particle diameter providing 84% accumulation is defined as that corresponding to volume D₈₄ᵥ and number D₈₄ₚ. The volume average particle diameter distribution index (GSDv) is calculated as (D₈₄ᵥ/D₁₆ᵥ)^{1/2} using these values.

In the exemplary embodiments, storage modulus G′A in 120° C. of the brilliant toner is preferably from 2000 to 20000. When the storage modulus G′A is 2000 or more, it is able to obtain easily desirable tone, and when the storage modulus G′A is 20000 or less, it is able to obtain desirable brilliance.

Storage moduli in the exemplary embodiments are measured as follows.

Storage moduli are obtained from dynamic viscoelasticity measured by sine wave vibration method. ARES device manufactured by Rheometric Scientific Inc., is used in the measurement of dynamic viscoelasticity.

The measurement of dynamic viscoelasticity is carried out by forming the toner as a tablet, setting the tablet into a parallel plate of 8 mm diameter, assuming normal force of 0, and then giving sine wave vibration at the vibration frequency of 6.28 rads/sec. The measurement starts from 20° C. and continues up to 100° C. by heating rate of 1° C./min. At this time, the interval of measuring time is 30 seconds.

In addition, stress dependency of distorted amount is confirmed from 20° C. to 100° C. by the interval of 10° C. before carrying out the measurement, and a range of distorted amount which satisfies a linear relationship between stress and distorted amount in respective temperature is obtained. The range of distorted amount in respective temperature is maintained in the range of from 0.01% to 0.5% during the measurement, and stress and distorted amount are controlled to become a linear relationship in all temperatures. The storage moduli are obtained using these measurement results.

Next, the component which constitutes the color toner in the exemplary embodiments will be described.

The color toner of the present exemplary embodiments may be used as a well-known toner of the related art containing colorant, and the configuration of the toner is not particularly limited. For example, the toner may have the same configuration, except that brilliant pigment which is used in the brilliant toner in the exemplary embodiments is changed to colorant described below.

Colorant

As a colorant used in the exemplary embodiment, a dye or a pigment may be used, but from the viewpoint of light resistance and water resistance, a pigment is desirable. The colorant may be used alone or in combination of two or more kinds thereof.

Examples of the colorant which may be used in the exemplary embodiment include the following.

Examples of a yellow colorant include chrome yellow, zinc yellow, yellow iron oxide, cadmium yellow, Hansa Yellow, Hansa Yellow 10G, Benzidine Yellow G, Benzidine Yellow GR, Suren Yellow, Quinoline Yellow, and Permanent Yellow NCG.

Examples of a blue colorant include Prussian Blue, cobalt blue, Alkali Blue Lake, Victoria Blue Lake, Fast Sky Blue, Indanthrene Blue BC, Aniline Blue, Ultramarine Blue, Calco Oil Blue, Methylene Blue Chloride, Phthalocyanine Blue, Phthalocyanine Green, and Malachite Green Oxalate.

Examples of a red colorant include red iron oxide, cadmium red, red lead oxide, mercury sulfide, Watchyoung Red, Permanent Red 4R, Lithol Red, Brilliant Carmine 3B, Brilliant Carmine 6B, Du Pont Oil Red, Pyrazolone Red, Rhodamine B Lake, Lake Red C, Rose Bengal, Eoxine Red, and Alizarin Lake.

Examples of a green colorant include chromium oxide, chromium green, Pigment Green, Malachite Green Lake and Final Yellow Green G.

Examples of an orange colorant include red chrome yellow, molybdenum orange, Permanent Orange GTR, Pyrazolone Orange, Vulkan Orange, Benzidine Orange G, Indanthrene Brilliant Orange RK and Indanthrene Brilliant Orange GK.

Examples of a violet colorant include manganese violet, Fast Violet B, and Methyl Violet Lake.

Examples of a black colorant include carbon black, copper oxide, manganese dioxide, aniline black, activated carbon, non-magnetic ferrite and magnetite.

In the color toner of the exemplary embodiments, the content of the colorant is preferably from 0.05% by weight to 12% by weight with respect to the binder resin, and more preferably from 0.5% by weight to 8% by weight.

Moreover, volume average particle diameter of the color toner in the exemplary embodiments is preferably from 1 μm to 10 μm, further preferably from 2 μm to 8 μm, and still further preferably from 3 μm to 6 μm.

In the exemplary embodiments, storage modulus G′B in 120° C. of the color toner is preferably from 500 to 3000, and further preferably from 750 to 2500, and still further preferably from 1000 to 2000. The measurement method of storage modulus G′B in 120° C. of the color toner is similar to the measurement method of storage modulus G′A in 120° C. of the brilliant toner.

Preparation Method of Toner

The brilliant toner and the color toner according to the exemplary embodiment (hereinafter, the toners in total may be simply called as “toner”) may be prepared by preparing brilliant toner particles or color toner particles (hereinafter, the particles in total may be called as “toner particles”) and then adding an external additive to the toner particles.

A method of preparing toner particles is not particularly limited, and examples thereof include well-known methods including a dry method such as a kneading and pulverizing method and wet methods such as an emulsification aggregation method and a suspension polymerization method.

In the kneading and pulverizing method, the respective materials including a colorant are mixed, the resultant is melted and kneaded with a kneader, an extruder or the like, and the obtained melted and kneaded material is coarsely pulverized and then pulverized with a jet mill or the like, followed by classification with an air classifier. As a result, toner particles having a desired particle diameter are obtained.

Among the methods, an emulsification aggregation method is preferable from the viewpoints that the shape and particle diameter of toner particles are easily controlled and a control range of a structure of toner particles, such as a core-shell structure, is wide. Hereinafter, a method of preparing toner particles with the emulsification aggregation method will be described in detail.

The emulsification aggregation method according to the exemplary embodiment includes an emulsification process of emulsifying base materials of the toner particles and forming resin particles (emulsified particles), an aggregation process of forming aggregates of the resin particles, and a coalescence process of coalescing the aggregates.

Emulsification Process

A resin particle dispersion may be prepared by, in addition to other well-known polymerization methods such as an emulsification polymerization method, a suspension polymerization method, and a dispersion polymerization method, a disperser applying a shearing force to a solution, in which an aqueous medium and binder resin are mixed to be emulsified. At this time, particles may be formed by heating a resin component to lower the viscosity thereof. In addition, in order to stabilize the dispersed resin particles, a dispersant may be used. Furthermore, when resin is dissolved in an oil solvent having relatively low solubility in water, the resin is dissolved in the solvent and particles thereof are dispersed in water with a dispersant and a polymer electrolyte, followed by heating or reduction in pressure to evaporate the solvent. As a result, the resin particle dispersion is prepared.

Examples of the aqueous medium include water such as distilled water or ion exchange water; and alcohols, and water is preferable.

In addition, examples of the dispersant which is used in the emulsification process include a water-soluble polymer such as polyvinyl alcohol, methyl cellulose, ethyl cellulose, hydroxyethyl cellulose, carboxymethyl cellulose, sodium polyacrylate, or sodium polymethacrylate; a surfactant such as an anionic surfactant (for example, sodium dodecylbenzenesulfonate, sodium octadecylsulfate, sodium oleate, sodium laurate, or potassium stearate), a cationic surfactant (for example, laurylamine acetate, stearylamine acetate, or lauryltrimethylammonium chloride), a zwitterionic surfactant (for example, lauryl dimethylamine oxide), or a nonionic surfactant (for example, polyoxyethylene alkyl ether, polyoxyethylene alkyl phenyl ether, or polyoxyethylene alkylamine); and an inorganic salt such as tricalcium phosphate, aluminum hydroxide, calcium sulfate, calcium carbonate, or barium carbonate.

Examples of the disperser which is used for preparing an emulsion include a homogenizer, a homomixer, a pressure kneader, an extruder, and a media disperser. With regard to the size of the resin particles, the average particle diameter (volume average particle diameter) thereof is preferably less than or equal to 1.0 μm, more preferably from 60 nm to 300 nm, and still more preferably from 150 nm to 250 nm. When the volume average particle diameter thereof is greater than or equal to 60 nm, the resin particles are likely to be unstable in the dispersion and thus the aggregation of the resin particles may be easy. In addition, when the volume average particle diameter thereof is less than or equal to 1.0 μm, the particle diameter distribution of the toner particles may be narrowed.

When a release agent particle dispersion is prepared, a release agent is dispersed in water with an ionic surfactant and a polyelectrolyte such as a polyacid or a polymeric base and the resultant is heated at a temperature higher than or equal to the melting point of the release agent, followed by dispersion using a homogenizer with which strong shearing force is applied or a pressure extrusion type disperser. Through the above-described process, a release agent particle dispersion is obtained. During the dispersion, an inorganic compound such as polyaluminum chloride may be added to the dispersion. Preferable examples of the inorganic compound include polyaluminum chloride, aluminum sulfate, high basic polyaluminum chloride (BAC), polyaluminum hydroxide, and aluminum chloride. Among these, polyaluminum chloride and aluminum sulfate are preferable. The release agent particle dispersion is used in the emulsification aggregation method, but may also be used when the brilliant toner is prepared in the suspension polymerization method.

Through the dispersion, the release agent particle dispersion having release agent particles with a volume average particle diameter of 1 μm or less is obtained. It is more preferable that the volume average particle diameter of the release agent particles be from 100 nm to 500 nm.

When the volume average particle diameter is greater than or equal to 100 nm, though it is also affected by properties of the binder resin to be used, in general, it is easy for a release agent component to be incorporated into the toner. In addition, when the volume average particle diameter is less than or equal to 500 nm, the dispersal state of the release agent in the toner may be satisfactory.

When a colorant dispersion and a brilliant pigment dispersion are prepared, a well-known dispersion method may be used. For example, general dispersion units such as a rotary-shearing homogenizer, a ball mill having a medium, a sand mill, a dyno mill, or an ultimizer are used, and the dispersion method is not limited thereto. The colorant is dispersed in water with an ionic surfactant and a polyelectrolyte such as a polyacid or a polymeric base.

The brilliant pigment and binder resin may be dispersed and dissolved in a solvent and mixed, and the resultant may be dispersed in water through phase inversion emulsification or shearing emulsification, thereby preparing a dispersion of the brilliant pigment coated with the binder resin.

Aggregation Process

In the aggregation process, the resin particle dispersion, the colorant dispersion, the brilliant pigment dispersion, the release agent dispersion and the like are mixed to obtain a mixture and the mixture is heated at the glass transition temperature or less of the resin particles and aggregated to form aggregated particles. In most cases, the aggregated particles are formed by adjusting the pH value of the mixture to be acidic under stirring. The pH value is preferably from 2 to 7. At this time, use of a coagulant is also effective.

In the aggregation process, the release agent dispersion and other various dispersions such as the resin particle dispersion may be added and mixed at once or may be added many times in separate portions.

As the coagulant, a surfactant having a reverse polarity to that of a surfactant which is used as the dispersant, an inorganic metal salt, and a divalent or higher valent metal complex may be preferably used. In particular, the metal complex is particularly preferable because the amount of the surfactant used may be reduced and the charging characteristics are improved.

Preferable examples of the inorganic metal salt include an aluminum salt and a polymer thereof. In order to obtain a narrower particle diameter distribution, a divalent inorganic metal salt is preferable to a monovalent inorganic metal salt, a trivalent inorganic metal salt is preferable to a divalent inorganic metal salt, and a tetravalent inorganic metal salt is preferable to a trivalent inorganic metal salt. Even in a case of inorganic metal salts having the same valence, a polymeric type of inorganic metal salt polymer is more preferable.

In the exemplary embodiment, in order to obtain a narrower particle diameter distribution, a tetravalent inorganic metal salt polymer containing aluminum is preferably used.

After the aggregated particles have desired particle diameters, the resin particle dispersion is additionally added (coating process). According to this, a toner having a configuration in which the surfaces of core aggregated particles are coated with resin may be prepared. In this case, the release agent, the colorant and the brilliant pigment are not easily exposed to the surface of the toner, which is preferable from the viewpoints of charging characteristics and developability. In a case of further addition, a coagulant may be added or the pH value may be adjusted before further addition.

Coalescence Process

In the coalescence process, under stirring conditions based on the aggregation process, by increasing the pH value of a suspension of the aggregated particles to be in a range of from 3 to 9, the aggregation is stopped. By performing heating at the glass transition temperature or higher of the resin, the aggregated particles are coalesced. In addition, when the resin is used for coating, the resin is also coalesced and coats the core aggregated particles. The heating time may be a period of time required for the coalescence and may be approximately from 0.5 hour to 10 hours.

After coalescing, cooling is carried out to obtain coalesced particles. In addition, in a cooling process, a cooling rate may be reduced around the glass transition temperature of the resin (the range of the glass transition temperature ±10° C.), that is, slow cooling may be carried out to promote crystallization.

The coalesced particles, which are obtained by coalescing, may be subjected to a sold-liquid separation process such as filtration, or, as necessary, a cleaning process and drying process to obtain toner particles.

In order to adjust charging, impart fluidity, and impart a charge exchange property, inorganic oxides or the like which are represented by silica, titania, and alumina may be added and attached to the obtained toner particles, as an external additive. The above-described processes may be performed with a V-shape blender, a Henschel mixer, a Loedige mixer or the like and the attachment is performed in plural steps. The amount of the external additive added is preferably in a range of from 0.1 part to 5 parts and more preferably in a range of from 0.3 part to 2 parts, with respect to 100 parts of the toner particles.

After the external addition, coarse toner particles may be removed, as necessary, using an ultrasonic sieving machine, a vibrating sieving machine, an air sieving machine or the like.

In addition to the above-described inorganic oxides or the like, other components (particles) such as a charge-controlling agent, organic particles, a lubricant, and an abrasive may be added as an external additive.

The charge-controlling agent is not particularly limited, and a colorless or light-color material is preferably used. Examples thereof include quaternary ammonium salt compounds, nigrosine compounds, a complex of aluminum, iron, chromium, or the like, and triphenylmethane pigments.

Examples of the organic particles include particles of vinyl resins, polyester resins, silicone resins, and the like, which are generally used as the external additive for surfaces of toner particles. In addition, the organic particles and inorganic particles are used as a fluidity auxiliary agent, a cleaning aid, or the like.

Examples of the lubricant include fatty acid amides such as ethylene bis stearamide and oleamide; and fatty acid metal salts such as zinc stearate and calcium stearate.

Examples of the abrasive include silica, alumina, and cerium oxide described above.

In order to adjust a ratio (G′A/G′B) of G′A to G′ B, storage modulus G′A in 120° C. of brilliant toner and storage modulus G/B in 120° C. of color toner are adjusted respectively, in the exemplary embodiments.

The storage modulus G′A in 120° C. of brilliant toner tends to rise by increasing the content of brilliant pigment in the brilliant toner, increasing the amount of the ion cross-linking due to metal ion such as Al in the toner or minimally adding inorganic particle such as silicon oxide.

On the other hand, the storage modulus G′B in 120° C. of color toner tends to rise by increasing the amount of the ion cross-linking due to metal ion such as Al in the toner, adding yellow pigment to the extent that it does not affect the color tone. The storage modulus G′B tends to decrease by using ester compound as the release agent. The adjustment of G′A and G′B is possible according to combination of these methods.

Moreover, during the aggregation process or before or after the aggregation process, it is preferable that the ion cross-linked amount in the toner is adjusted by adding a chelating agent which forms a chelate compound with a metal ion (chelating agent addition process) and removing redundant metal ions from the toner from the viewpoint of controlling toner particle size distribution.

In addition, when a cover process in which a cover layer is formed by adhering a binder resin particle on the surface of aggregated particle formed through the aggregation process is carried out, the chelating agent may be added during the aggregation process or the cover process or before or after the processes.

In the aggregation process, it is preferable to promote the growth of the aggregated particle using a large amount of coagulant from the viewpoint of suppressing toner fine powder generation. However, if a larger amount of coagulant is used and the amount of metal ion in the toner becomes large, the characteristics such as chargeability of the toner may be adversely affected. In contrast, the generation of the toner fine power is suppressed without adversely affecting the characteristics of the toner if redundant metal ion is removed by using the chelating agent.

Furthermore, a water-soluble chelating agent may be used as a chelating agent which may be used in the exemplary embodiments. Since water-insoluble chelating agent has poor dispersibility in the raw material dispersion, the seizing of metal ion due to coagulant may not be sufficient in the toner.

In so far as a chelating agent is a well-known water-soluble chelating agent, the chelating agent is not particularly limited. For example, oxycarboxylic acid such as tartaric acid, citric acid, or gluconic acid, iminodiacetic acid (IDA), nitrilotriacetic acid (NTA), ethylene diamine tetra acetic acid (EDTA), or sodium 3-hydroxy-2,2′-iminodisuccinate (HIDS) may be suitably used.

Developer

The toner according to the exemplary embodiment may be used as a single-component developer as it is or a two-component developer in which a carrier is mixed with the toner.

The carrier which may be used for the two-component developer is not particularly limited, and a well-known carrier may be used. For example, magnetic metals such as iron oxide, nickel, or cobalt and magnetic oxides such as ferrite or magnetite, a resin-coated carrier which has a resin coating layer on the surface of a core material formed of magnetic metal or magnetic oxide, and a magnetic powder-dispersed carrier may be used. In addition, a resin-dispersed carrier in which a conductive material or the like is dispersed in a matrix resin may be used.

Examples of the coating resin and the matrix resin which are used for the carrier include polyethylene, polypropylene, polystyrene, polyvinyl acetate, polyvinyl alcohol, polyvinyl butyral, polyvinyl chloride, polyvinyl ether, polyvinylketone, vinyl chloride-vinyl acetate copolymer, styrene-acrylic acid copolymer, straight silicone resin having organosiloxane bonds or a modified product thereof, fluororesin, polyester, polycarbonate, phenol resin, and epoxy resin. However, the coating resin and the matrix resin are not limited to these examples.

Examples of the conductive material include metals such as gold, silver, and copper, carbon black, titanium oxide, zinc oxide, barium sulfate, aluminum borate, potassium titanate, and tin oxide. However, the conductive material is not limited to these examples.

Examples of the core material of the carrier include a magnetic metal such as iron, nickel or cobalt, a magnetic oxide such as ferrite or magnetite, and glass beads. In order to apply a magnetic brush method to the carrier, a magnetic material is preferable. In general, the volume average particle diameter of the core material of the carrier is in a range of from 10 μm to 500 μm and preferably in a range of from 30 μm to 100 μm.

In order to coat the surface of the core material of the carrier with resin, there may be used, for example, a coating method using a coating layer-forming solution which is obtained by dissolving the coating resin and, as necessary, various additives in an appropriate solvent. The solvent is not particularly limited and may be selected according to coating resin to be used, coating aptitude or the like.

Specific examples of the resin coating method include a dipping method in which the core material of the carrier is dipped in the coating layer-forming solution, a spray method in which the coating layer-forming solution is sprayed on the surface of the core material of the carrier, a fluid bed method in which the coating layer-forming solution is sprayed on the core material of the carrier in a state of floating through flowing air, and a kneader coater method in which the core material of the carrier and the coating layer-forming solution are mixed in a kneader coater and the solvent is removed.

In the two-component developer, the mixing ratio (weight ratio) of the toner according to the exemplary embodiment and the carrier is preferably in a range of from 1:100 to 30:100 (brilliant toner:carrier) and more preferably in a range of from 3:100 to 20:100.

Image Forming Apparatus and Image Forming Method

An image forming apparatus according to the exemplary embodiment includes plural toner image forming units which includes at least a first toner image forming unit that forms a brilliant toner image using a brilliant toner containing a brilliant pigment, and a second toner image forming unit that forms a color toner image using a color toner containing a colorant, a transfer unit that transfers at least the brilliant toner image and the color toner image onto a recording medium so as to superimpose with each other and a fixing unit that fixes at least the brilliant toner image and the color toner image on the recording medium. Regarding the brilliant toner and the color toner, a ratio (G′A/G′B) of G′A to G′B needs to satisfy a relationship of 1≦G′A/G′B≦10, when a storage modulus in 120° C. of the brilliant toner is G′A and a storage modulus in 120° C. of the color toner is G′B.

The toner image forming unit according to the exemplary embodiment may include a latent image holding member, a charging unit that charges the surface of the latent image holding member, an electrostatic charge image forming unit that forms an electrostatic charge image to the surface of the latent image holding member, and a developing unit that develops the electrostatic charge image using a developer containing a brilliant toner or a color toner and forms a toner image.

With the image forming apparatus according to the exemplary embodiment, an image forming method according to the exemplary embodiment is carried out including plural processes of forming toner images which includes at least a process of forming a first toner image of a brilliant toner image using a brilliant toner containing a brilliant pigment, and a process of forming a second toner image of a color toner image using a color toner containing a colorant, transferring at least the brilliant toner image and the color toner image onto a recording medium so as to superimpose with each other, and fixing at least the brilliant toner image and the color toner image on the recording medium, in which the ratio (G′A/G′B) of G′A to G′B satisfies a relationship of 1≦G′A/G′B≦10, when a storage modulus in 120° C. of the brilliant toner is G′A and a storage modulus in 120° C. of the color toner is G′B.

The image forming apparatus according to the exemplary embodiment may be, for example, an image forming apparatus that sequentially and repeatedly primary transfers each toner image held on the latent image holding member to an intermediate transfer body or a tandem type image forming apparatus that arranges plural latent image holding members having a developing unit for each color on the intermediate transfer body in series.

The image forming apparatus according to the exemplary embodiment may be a cartridge structure (process cartridge) in which a portion including the developing unit that accommodates the developer is detachable and attachable to the image forming apparatus and may be a cartridge structure (toner cartridge) in which a portion that accommodates a supplement toner to be supplied to the developing unit is detachable and attachable to the image forming apparatus.

Hereinafter, with reference to the drawing, the image forming apparatus according to the exemplary embodiment will be described.

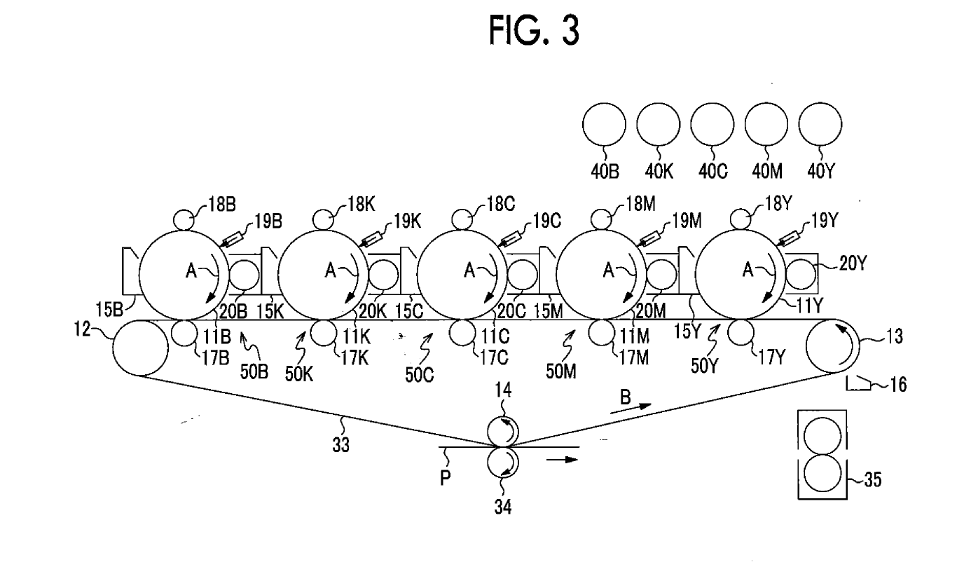

FIG. 3 is a configuration diagram schematically illustrating an example of the image forming apparatus according to the exemplary embodiment. The image forming apparatus according to the exemplary embodiment employs a tandem type configuration in which plural photoreceptors as a latent image holing member, that is, plural image forming units are provided.

As shown in FIG. 3, in the image forming apparatus according to the exemplary embodiment, five image forming units 50Y, 50M, 50C, 50K, and 50B that respectively form a toner image of yellow, magenta, cyan, black, and brilliant silver are arranged in parallel (in a tandem shape) with a space therebetween. In addition, the respective image forming units are arranged in the order of the image forming units 50Y, 50M, 50C, 50K, and 50B from the upper stream side of the rotational direction of an intermediate transfer belt 33.

Herein, since respective image forming units 50Y, 50M, 50C, 50K, and 50B have the same configuration except that the color of toners in accommodated developers is different from each other, the image forming unit 50Y that forms a yellow image will be described as a representative example. In addition, descriptions of the respective image forming units 50M, 50C, 50K, and 50B are omitted by assigning referential marks of magenta (M), cyan (C), black (K), and brilliant silver (B) instead of yellow (Y) to a portion equivalent to the image forming unit 50Y.

The yellow image forming unit 50Y includes a photoreceptor 11Y as a latent image holding member. The photoreceptor 11Y is driven by a driving unit (not illustrated) to rotate at a predetermined process speed along the direction of the arrow A shown in the drawing. As the photoreceptor 11Y, for example, an organic photoreceptor having sensitivity in the infrared region is used.

A charging roll (charging unit) 18Y is provided in the upper area of the photoreceptor 11Y. A predetermined voltage is applied to the charging roll 18Y by a power supply (not illustrated) and the surface of the photoreceptor 11Y is charged to a predetermined potential.

Around the photoreceptor 11Y, an exposure apparatus (electrostatic charge image forming unit) 19Y that exposes the surface of the photoreceptor 11Y and forms an electrostatic charge image is disposed on the further downstream side of the rotational direction of the photoreceptor 11Y than the charging roll 18Y. In addition, an LED array which is capable of miniaturization is used herein as the exposure apparatus 19Y from the viewpoint of an efficient use of space. However, the exposure apparatus 19Y is not limited thereto, and there is no problem in a case where other electrostatic charge image forming units utilizing a laser beam or the like is used.

Around the photoreceptor 11Y, a developing apparatus (developing unit) 20Y that includes a developer holding member which holds a yellow developer is disposed on the further downstream side of the rotational direction of the photoreceptor 11Y than the exposure apparatus 19Y. The developing apparatus 20Y visualizes the electrostatic charge image formed on the surface of the photoreceptor 11Y using a yellow toner and forms a toner image on the surface of the photoreceptor 11Y.

In the lower part of the photoreceptor 11Y, an intermediate transfer belt (primary transfer unit) 33 that performs primary transfer of the toner image formed on the surface of the photoreceptor 11Y is disposed across the lower part of the five photoreceptors 11Y, 11M, 11C, 11K, and 11B. This intermediate transfer belt 33 is pressed against the surface of the photoreceptor 11Y by a primary transfer roll 17Y. In addition, the intermediate transfer belt 33 is stretched by three rolls such as a driving roll 12, a supporting roll 13 and a bias roll 14, and is made to circumferentially move in the direction of the arrow B at a movement rate equal to the process speed of the photoreceptor 11Y. A yellow toner image is primary transferred onto the surface of the intermediate transfer belt 33. Further, the respective toner images of magenta, cyan, black, and brilliant silver are primary transferred thereon in sequence.

Around the photoreceptor 11Y, a cleaning apparatus 15Y for cleaning residual toner or retransferred toner on the surface of the photoreceptor 11Y is disposed on the further downstream side of the rotational direction (direction of the arrow A) of the photoreceptor 11Y than the primary transfer roll 17Y. The cleaning blade in the cleaning apparatus 15Y is mounted so as to come into contact under pressure with the surface of the photoreceptor 11Y in the counter direction.

A secondary transfer roll (secondary transfer unit) 34 comes into contact under pressure with the bias roll 14 stretching the intermediate transfer belt 33, with the intermediate transfer belt 33 interposed therebetween. The toner images that have been primary transferred and laminated on the surface of the intermediate transfer belt 33 are electrostatically transferred onto the surface of recording paper (recording medium) P that is supplied from a paper cassette (not illustrated), at the pressure contact area between the bias roll 14 and the secondary transfer roll 34.

A fixing machine (fixing unit) 35 for fixing the toner images that are multiple-transferred on the recording paper P to the surface of the recording paper P under heat and pressure, to make the toner images into a permanent image, is disposed downstream of the secondary transfer roll 34.

Examples of the fixing machine 35 include a fixing belt which has a belt shape and uses a low-surface energy material represented by a fluororesin component or a silicone resin for the surface thereof and a cylindrically shaped fixing roll which uses a low-surface energy material represented by a fluororesin component or a silicone resin for the surface thereof.

Next, the operations of the respective image forming units 50Y, 50M, 50C, 50K, and 50B that form the respective images of yellow, magenta, cyan, black, and brilliant silver will be described. Since the operations of the respective image forming units 50Y, 50M, 50C, 50K, and 50B are the same in the respective units, the operation of the image forming unit 50Y for a yellow image will be described as a representative case.

In the yellow image forming unit 50Y, the photoreceptor 11Y rotates in the direction of the arrow A at a predetermined process speed. The surface of the photoreceptor 11Y is negatively charged by the charging roll 18Y to a predetermined potential. Thereafter, the surface of the photoreceptor 11Y is exposed by the exposure apparatus 19Y, and thereby an electrostatic charge image is formed in accordance with the image information. Subsequently, the toner that has been negatively charged is reverse developed by the developing apparatus 20Y, and the electrostatic charge image formed on the surface of the photoreceptor 11Y is converted into a visual image at the surface of the photoreceptor 11Y, so that a toner image is formed. Thereafter, the toner image on the surface of the photoreceptor 11Y is primary transferred onto the surface of the intermediate transfer belt 33 by the primary transfer roll 17Y. After the primary transfer, the photoreceptor 11Y is treated such that the transfer remnant components such as residual toner on the surface of the photoreceptor 11Y are scraped off and cleaned by the cleaning blade of the cleaning apparatus 15Y, and the photoreceptor 11Y is prepared for the next image forming step.

The operation as described above is carried out for the respective image forming units 50Y, 50M, 50C, 50K, and 50B and the toner images that have been converted into a visual image at the respective surfaces of the photoreceptors 11Y, 11M, 11C, 11K, and 11B are sequentially multiple transferred onto the surface of the intermediate transfer belt 33. The respective toner images of different colors are multiple transferred in the order of yellow, magenta, cyan, black, and brilliant silver, and also in the bicolor mode and tricolor mode, those toner images of necessary colors only are single transferred or multiple transferred in this order.

In addition, in the image forming apparatus shown in FIG. 3, the toner images are multiple transferred in the order of yellow, magenta, cyan, black, and brilliant silver. However, in the exemplary embodiment, by switching the positional relationship between the image forming units 50Y, 50M, 50C, 50K, and 50B, the order of the multiple transfer of the toner images may be changed.

Thereafter, the toner images that have been single transferred or multiple transferred onto the surface of the intermediate transfer belt 33, are secondary transferred onto the surface of the recording paper P that has been conveyed from a paper cassette (not illustrated), by the secondary transfer roll 34, and the toner images are subsequently fixed by being heated and pressed in the fixing machine 35. Any toner remaining on the surface of the intermediate transfer belt 33 after the secondary transfer is cleaned by a belt cleaner 16 composed of a cleaning blade for the intermediate transfer belt 33.

The yellow image forming unit 50Y is configured as a process cartridge in which the developing apparatus 20Y which includes a developer holding member that holds the yellow developer, the photoreceptor 11Y, the charging roll 18Y, and the cleaning apparatus 15Y are integrated, and which is detachable from the main body of the image forming apparatus. Furthermore, the image forming units 50M, 50C, 50K, and 50B are also configured as process cartridges, as in the case of the image forming unit 50Y.

The toner cartridges 40Y, 40M, 40C, 40K, and 40B are cartridges which accommodate the toners of the respective colors, and are detachable from the image forming apparatus. Each toner cartridge is connected to the corresponding developing apparatus for each color, via a toner supply pipe that is not illustrated in the drawing. When the amount of the toner accommodated in each toner cartridge decreases, a replacement of this toner cartridge is made.

In the exemplary embodiments, a ratio of the applied amount of brilliant toner to the applied amount of color toner (total amount of color toners when two or more kinds of color toners are used) is preferably 1:5 to 1:4, and more preferably 1:1 to 1:3.

### EXAMPLES

The present exemplary embodiment will be described below in more detail based on examples and comparative examples, but the present exemplary embodiment is not limited to the following examples. In addition, “part(s)” and “%” represent “part(s) by weight” and “% by weight” unless otherwise specified.

Synthesis of Binder resin 1

Dimethyl adipate: 74 parts

Dimethyl terephthalate: 192 parts

Bisphenol A ethylene oxide adduct: 216 parts

Ethylene glycol: 38 parts

Tetrabutoxytitanate (catalyst): 0.037 part

The above components are put in a two-necked flask dried by heating, nitrogen gas is put into the container to maintain an inert gas atmosphere, and the temperature is raised while stirring. Thereafter, a copolycondensation reaction is caused at 160° C. for 7 hours, and then the temperature is raised to 220° C. while the pressure is slowly reduced to 10 Torr, and the temperature is held for 4 hours. The pressure is temporarily returned to normal pressure, and then 9 parts of trimellitic anhydride is added. The pressure is then slowly reduced again to 10 Torr, and the temperature is held at 220° C. for an hour, thereby synthesizing binder resin 1.

Preparation of Binder resin Dispersion 1

Binder resin 1: 160 parts

Ethyl acetate: 233 parts

Aqueous sodium hydroxide solution (0.3 N):0.1 part

The above components are put in a 1000 ml separable flask, followed by heating at 70° C., and the resultant is stirred with a Three-One motor (manufactured by Shinto Scientific Co., Ltd.), thereby preparing a resin mixture solution. While this resin mixture solution is further stirred, 373 parts of ion exchange water is gradually added thereto to cause phase inversion emulsification, and the solvent is removed, thereby obtaining a binder resin dispersion (solid content concentration: 30%).

Synthesis of Binder Resin 2 and Preparation of Binder Resin Dispersion 2

A binder resin 2 is prepared in the same manner as in the synthesis of the binder resin 1, except that the amount of dimethyl adipate is changed to 55 parts, the amount of dimethyl terephthalate is changed to 203 parts, and the temperature is raised to 230° C. and held for 6 hours while the temperature is raised to 220° C. and held for 4 hours in the synthesis of the binder resin 1.

Additionally, a binder resin dispersion 2 is prepared by using the binder resin 2 in a manner similar to the preparation of the binder resin dispersion 1.

Synthesis of Binder Resin 3 and Preparation of Binder Resin Dispersion 3

A binder resin 3 is prepared in the same manner as in the synthesis of the binder resin 2, except that the amount of dimethyl terephthalate is changed to 199 parts and the amount of trimellitic anhydride is changed to 4 parts from the amounts used in the synthesis of the binder resin 2, respectively.

Additionally, a binder resin dispersion 3 is prepared by using the binder resin 3 in a manner similar to the preparation of the binder resin dispersion 2.

Synthesis of Binder resin 4 and Preparation of Binder resin Dispersion 4

A binder resin 4 is prepared in the same manner as in the synthesis of the binder resin 1, except that the amount of dimethyl adipate is changed to 88 parts, the amount of dimethyl terephthalate is changed to 178 parts, and the temperature is raised to 220° C. and held for 3 hours while the temperature is raised to 220° C. and held for 4 hours in the synthesis of the binder resin 1.

Additionally, a binder resin dispersion 4 is prepared by using the binder resin 4 in a manner similar to the preparation of the binder resin dispersion 1.

Preparation of Brilliant Pigment Dispersion

Aluminum pigment (manufactured by SHOWA ALUMINUM POWDER K.K., 2173EA, 6 μm): 100 parts

Anionic surfactant (manufactured by DAI-ICHI KOGYO SEIYAKU CO., LTD., NEOGEN R): 1.5 parts

Ion exchange water: 400 parts

A solvent is removed from a paste of the aluminum pigment and the pigment is mechanically pulverized to 5.2 μm using Star Mill (manufactured by Ashizawa Finetech Ltd., LMZ) and classified. Thereafter, the surfactant and the ion exchange water is mixed and then the resultant is dispersed using an emulsification dispersing machine CAVITRON (manufactured by Pacific Machinery & Engineering Co., Ltd., CR 1010) for 1 hour. As a result, a brilliant pigment dispersion, in which brilliant pigment particles (aluminum pigment particles) are dispersed, is prepared (solid content concentration: 20%). The dispersion diameter of the pigment is 5.2 μm.

Preparation of Yellow Colorant Dispersion 1

C. I. Pigment Yellow 74 (monoazo pigment, manufactured by Dainichiseika Color & Chemicals Mfg. Co., Ltd., Seika Fast Yellow 2054): 50 parts

Ionic surfactant NEOGEN RK (manufactured by DAI-ICHI KOGYO SEIYAKU CO., LTD.): 5 parts

Ion exchange water: 192.9 parts

The above components are mixed and subjected to a process at 240 MPa for 10 minutes by Ultimizer (manufactured by Sugino Machine, Ltd.), thereby obtaining a yellow colorant dispersion 1. The solid content concentration thereof is 20%.

Preparation of Yellow Colorant Dispersion 2

A yellow colorant dispersion 2 is prepared in the same manner as in the preparation of the yellow colorant dispersion 1, except that the colorant is changed to C.I. Pigment Yellow (disazo pigment, manufactured by Dainichiseika Color & Chemicals Mfg. Co., Ltd., Seika Fast Yellow 2400B). The solid content concentration thereof is 20%.

Preparation of Yellow Colorant Dispersion 3

A yellow colorant dispersion 3 is prepared in the same manner as in the preparation of the yellow colorant dispersion 1, except that the colorant is changed to C. I. Pigment Yellow 185 (iso-indolinone pigment, manufactured by Clariant K.K., Hansa Yellow 5GX01). The solid content concentration thereof is 20%.

Preparation of Yellow Colorant Dispersion 4

A yellow colorant dispersion 4 is prepared in the same manner as in the preparation of the yellow colorant dispersion 1, except that the colorant is changed to C. I. Pigment Yellow 138 (quinophtalone pigment, manufactured by BASF Corporation, Paliotol Yellow L0960HD). The solid content concentration thereof is 20%.

Preparation of Cyan Colorant Dispersion

A cyan colorant dispersion is prepared in the same manner as in the preparation of the yellow colorant dispersion 1, except that the colorant is changed to C.I. Pigment Blue 15:3 (phthalocyanine pigment, manufactured by Dainichiseika Color & Chemicals Mfg. Co., Ltd., Cyanine Blue 4937). The solid content concentration thereof is 20%.

### Preparation of Magenta Colorant Dispersion

A magenta colorant dispersion is prepared in the same manner as in the preparation of the yellow colorant dispersion 1, except that the colorant is changed to C. I. Pigment Red 122 (quinacridone pigment, manufactured by Dainichiseika Color & Chemicals Mfg. Co., Ltd., Chromofine Magenta 6887). The solid content concentration thereof is 20%.

Preparation of Release agent Dispersion

Carnauba wax (manufactured by TOA KASEI CO., LTD., RC-160): 50 parts

Anionic surfactant (manufactured by DAI-ICHI KOGYO SEIYAKU CO., LTD., NEOGEN RK): 1.0 part

Ion exchange water: 200 parts

The above components are mixed and heated to 95° C., and dispersed using a homogenizer (manufactured by IKA, Ultra Turrax T50). Thereafter, the resultant is dispersed for 360 minutes by using a Manton-Gaulin high pressure homogenizer (manufactured by Gaulin Corporation), thereby preparing a release agent dispersion (solid content concentration: 20%) in which release agent particles having a volume average particle diameter of 0.23 μm are dispersed.

Preparation of Brilliant Silver Toner 1

Brilliant pigment dispersion: 150 parts

Binder resin dispersion 1: 405 parts

Release agent dispersion: 50 parts

The above components are put into a 2 L cylindrical stainless steel container, followed by dispersion and mixing for 10 minutes with a homogenizer (manufactured by IRA, ULTRA-TURRAX T50) while applying a shearing force at 4000 rpm. Next, 1.75 parts of 10% nitric acid aqueous solution of polyaluminum chloride as a coagulant is gradually added dropwise, followed by dispersion and mixing with the homogenizer at 5000 rpm for 15 minutes. As a result, a raw material dispersion is obtained.

Thereafter, the raw material dispersion is put into a polymerization kettle which includes a stirring device using a four-paddle stirring blade for generating a laminar flow and a thermometer, followed by heating with a mantle heater under stirring at 1000 rpm to promote the growth of aggregated particles at 54° C. At this time, the pH value of the raw material dispersion is adjusted to a range of 2.2 to 3.5 using 0.3 N nitric acid and 1N sodium hydroxide aqueous solution. The resultant is held in the above-described pH value range for about 2 hours and aggregated particles are formed.

Next, 125 parts of the binder resin dispersion 1 is further added thereto so that the resin particles of the binder resin are allowed to adhere to the surfaces of the aggregated particles. The temperature is further raised to 56° C., and the aggregated particles are adjusted while observing the particle diameter and the forms of the particles with an optical microscope and a MULTISIZER II. 3.25 parts of chelating agent (HIDS manufactured by NIPPON SHOKUBAI CO., LTD.) is added and subsequently pH value is adjusted at 7.8 using 5% sodium hydroxide aqueous solution and maintained for 15 minutes. Subsequently, in order to cause the aggregated particles to coalesce, the pH value is increased to 8.0 and then the temperature is raised to 67.5° C. After the coalescence of the aggregated particles is confirmed with the optical microscope, the pH value is decreased to 6.0 while maintaining the temperature at 67.5° C. After 1 hour, heating is stopped and cooling is performed at a temperature decreasing rate of 1.0° C./min. The particles are then sieved through a 40 μm mesh, repeatedly washed with water, and then dried in a vacuum dryer. As a result, toner particles are obtained. The obtained toner particles have a volume average particle diameter of 11.5 μm. 1.5 parts of colloidal silica (manufactured by Nippon Aerosil Co., Ltd., R972) is mixed with 100 parts of the obtained toner particles using a Henschel mixer at 30 m/sec in the circumferential speed for 2 minutes. Thereby, a brilliant silver toner 1 is prepared.

Storage modulus G′ A in 120° C. of the brilliant silver toner 1 is 2050 Pa.

Preparation of Brilliant Silver Toners 2 to 5

Brilliant silver toners 2 to 5 are prepared in the same manner as in the preparation of the brilliant silver toner 1, except that compositions of respective dispersions are changed as shown in Table 1. The brilliant silver toners are shown in Table 1, along with the brilliant silver toner 1. The value of the binder resin dispersion is the value to which 125 parts are further added.

TABLE 1

| | Binder resin | | Brilliant | Release | |
|---|---|---|---|---|---|
| | Dispersion | | Pigment | agent | Storage |
| | Kind of | | Dispersion | Dispersion | modulus |
| | Dispersion | Part | Part | Part | G′A (Pa) |
| Brilliant | 1 | 530 | 150 | 50 | 2050 |
| Silver Toner 1 | | | | | |
| Brilliant | 1 | 505 | 150 | 75 | 1920 |
| Silver Toner 2 | | | | | |
| Brilliant | 2 | 530 | 150 | 50 | 10600 |
| Silver Toner 3 | | | | | |
| Brilliant | 3 | 510 | 150 | 70 | 19800 |
| Silver Toner 4 | | | | | |
| Brilliant | 3 | 530 | 150 | 50 | 20600 |
| Silver Toner 5 | | | | | |

Preparation of Yellow Toner 1

Yellow colorant dispersion 1: 50 parts

Binder resin dispersion 1: 475 parts

Release agent dispersion: 50 parts

The above components are put into a 2 L cylindrical stainless steel container, followed by dispersion and mixing for 10 minutes with a homogenizer (manufactured by IKA, ULTRA-TURRAX T50) while applying a shearing force at 4000 rpm. Next, 1.75 parts of 10% nitric acid aqueous solution of polyaluminum chloride as a coagulant is gradually added dropwise, followed by dispersion and mixing with the homogenizer at 5000 rpm for 15 minutes. As a result, a raw material dispersion is obtained.

Thereafter, the raw material dispersion is put into a polymerization kettle which includes a stirring device using a four-paddle stirring blade and a thermometer, followed by heating with a mantle heater under stirring at 600 rpm to promote the growth of aggregated particles at 50° C. At this time, the pH value of the dispersion is adjusted to a range of 2.2 to 3.5 using 0.3 N nitric acid and 1 N sodium hydroxide aqueous solution. The resultant is held in the above-described pH value range for about 2 hours and aggregated particles are formed.

Next, 125 parts of the binder resin dispersion 1 is further added thereto so that the resin particles of the binder resin are allowed to adhere to the surfaces of the aggregated particles. The temperature is further raised to 52° C., and the aggregated particles are adjusted while observing the particle diameter and the forms of the particles with an optical microscope and a MULTISIZER II. Thereafter 2.25 parts of chelating agent (HIDS manufactured by NIPPON SHOKUBAI CO., LTD.) is added and subsequently pH value is adjusted at 7.8 using 5% sodium hydroxide aqueous solution and maintained for 15 minutes. Subsequently, in order to cause the aggregated particles to coalesce, the pH value is increased to 8.0 and then the temperature is raised to 67.5° C. After the coalescence of the aggregated particles is confirmed with the optical microscope, the pH value is decreased to 6.0 while maintaining the temperature at 67.5° C. After 1 hour, heating is stopped and cooling is performed at a temperature decreasing rate of 1.0° C./min. The particles are then sieved through a 20 μm mesh, repeatedly washed with water, and then dried in a vacuum dryer. As a result, toner particles are obtained. The obtained toner particles have a volume average particle diameter of 5.5 μm.

1.5 parts of colloidal silica (manufactured by Nippon Aerosil Co., Ltd., R972) is mixed with 100 parts of the obtained toner particles using a Henschel mixer at 30 m/sec in the circumferential speed for 2 minutes. Thereby, a yellow toner 1 is prepared.

Storage modulus G′B in 120° C. of the yellow toner 1 is 2110 Pa.

Preparation of Yellow Toners 2 to 25

Yellow toners 2 to 25 are prepared in the same manner as in the preparation of the yellow toner 1, except that compositions of respective dispersions are changed as shown in Table 2. The yellow toners are shown in Table 2, along with the yellow toner 1. The value of the binder resin dispersion is the value to which 125 parts are further added.

TABLE 2

| | Binder resin | | Yellow Pigment | | Release | |
|---|---|---|---|---|---|---|
| | Dispersion | | Dispersion | | agent | Storage |
| | Kind of | | Kind of | | Dispersion | modulus |
| | Dispersion | Part | Pigment | Part | Part | G′B (Pa) |
| Yellow | 1 | 600 | 1 | 50 | 50 | 2110 |
| Toner 1 | | | | | | |
| Yellow | 1 | 475 | 1 | 50 | 75 | 1080 |
| Toner 2 | | | | | | |
| Yellow | 4 | 470 | 1 | 50 | 50 | 240 |
| Toner 3 | | | | | | |
| Yellow | 4 | 500 | 1 | 50 | 80 | 190 |
| Toner 4 | | | | | | |
| Yellow | 2 | 500 | 1 | 50 | 50 | 4290 |
| Toner 5 | | | | | | |
| Yellow | 1 | 455 | 2 | 95 | 50 | 2960 |
| Toner 6 | | | | | | |
| Yellow | 1 | 430 | 2 | 95 | 75 | 1510 |
| Toner 7 | | | | | | |
| Yellow | 4 | 425 | 2 | 95 | 80 | 260 |
| Toner 8 | | | | | | |
| Yellow | 4 | 455 | 2 | 95 | 50 | 340 |
| Toner 9 | | | | | | |
| Yellow | 2 | 455 | 2 | 95 | 50 | 6000 |
| Toner 10 | | | | | | |
| Yellow | 1 | 480 | 3 | 70 | 50 | 2750 |
| Toner 11 | | | | | | |
| Yellow | 1 | 448 | 3 | 70 | 82 | 1400 |
| Toner 12 | | | | | | |
| Yellow | 4 | 480 | 3 | 70 | 50 | 310 |
| Toner 13 | | | | | | |
| Yellow | 4 | 450 | 3 | 70 | 80 | 240 |
| Toner 14 | | | | | | |
| Yellow | 2 | 480 | 3 | 70 | 50 | 5580 |
| Toner 15 | | | | | | |
| Yellow | 1 | 480 | 4 | 70 | 50 | 2600 |
| Toner 16 | | | | | | |
| Yellow | 1 | 447 | 4 | 70 | 83 | 1330 |
| Toner 17 | | | | | | |
| Yellow | 4 | 482 | 4 | 70 | 48 | 300 |
| Toner 18 | | | | | | |
| Yellow | 4 | 448 | 4 | 70 | 82 | 230 |
| Toner 19 | | | | | | |
| Yellow | 2 | 480 | 4 | 70 | 50 | 5280 |
| Toner 20 | | | | | | |
| Yellow | 1 | 480 | 5 | 70 | 50 | 2560 |
| Toner 21 | | | | | | |
| Yellow | 1 | 439 | 5 | 70 | 91 | 1300 |
| Toner 22 | | | | | | |
| Yellow | 4 | 480 | 5 | 70 | 50 | 290 |
| Toner 23 | | | | | | |
| Yellow | 4 | 450 | 5 | 70 | 80 | 230 |
| Toner 24 | | | | | | |
| Yellow | 2 | 482 | 5 | 70 | 48 | 5190 |
| Toner 25 | | | | | | |

Preparation of Magenta Toner

A magenta toner is prepared in the same manner as in the preparation of the yellow toner 1, except that the yellow colorant dispersion 1 is changed to the magenta colorant dispersion.

A storage modulus G′B in 120° C. of the magenta toner is 2530 Pa.

Preparation of Cyan Toner

A cyan toner is prepared in the same manner as in the preparation of the yellow toner 1, except that the yellow colorant dispersion 1 is changed to the cyan colorant dispersion.

A storage modulus G′B in 120° C. of the cyan toner is 2020 Pa.

Preparation of Carrier

Ferrite particle (volume average particle diameter: 35 μm): 100 parts

Toluene: 14 parts

Perfluorooctyl ethyl acrylate-methyl methacrylate copolymer (critical surface tension: 24 dyn/cm, copolymerization ratio: 2:8, weight average molecular weight: 77000): 1.6 parts

Carbon black (product name: VXC-72 manufactured by Cabot Corporation, volume resistivity: 100 Ωcm or less): 0.12 part Cross-linked melamine resin particle (average particle diameter: 0.3 μm, toluene insoluble): 0.3 part

First, carbon black diluted with toluene is added to perfluorooctyl ethyl acrylate-methyl methacrylate copolymer, and then the resultant is dispersed in a sand mill. The above components other than ferrite particle are dispersed in the obtained dispersion with a stirrer for 10 minutes, thereby preparing a coating layer-forming solution. Then, the coating layer-forming solution and ferrite particles are put in a vacuum degassing kneader, followed by stirring at 60° C. for 30 minutes. Thereafter, the pressure is reduced while removing toluene, and a resin coating layer is formed, thereby preparing a carrier.

Preparation of Developer

Regarding brilliant silver toners 1 to 5, yellow toners 1 to 25, magenta toner, and cyan toner, 36 parts of the toner and 414 parts of the carrier are put in a V blender, stirred for 20 minutes, and sieved at 212 μm, thereby preparing a developer.

Evaluation 1

A developer is filled in a developing unit of Color 1000 Press manufactured by Fuji Xerox Co., Ltd., and 100000 sheets of solid image in which the applied amount of brilliant silver toner is 4.0 g/cm² and the applied amount of yellow toner is 4.0 g/cm² are formed on a coated paper (OK Topcoat+Paper manufactured by Oji Paper Co., Ltd., surface roughness Rz=1.98 μm) and a label paper (OPP50C (A) PAT11LL manufactured by LINTEC Corporation, surface roughness Rz=0.27 μm) at a fixing temperature of 180° C. (a pressure roll temperature of 100° C.).

Tone

Tone in a 100000-th label paper is evaluated, visually. Evaluation standards are as follows and Evaluation Standards up to C are acceptable.

Evaluation Standards

A: Problems are not confirmed on tones.

B: Dullness of color is slightly confirmed.

C: Acceptable dullness of color is confirmed.

D: Dullness of color is severe, and therefore it is not acceptable.

Brilliance

When a 100000-th coated paper is irradiated with light at an angle of 45° with respect to vertical direction of the solid image surface using a three dimensional spectrum variable angle colorimeter DDS 5000 (manufactured by NIPPON DENSHOKU INDUSTRIES CO., LTD.), a lightness index L*45° which receives light in the vertical direction of the solid image surface, a lightness index L*15° which receives light at an angle of −30° with respect to vertical direction of the solid image surface, and a lightness index L*110° which receives light at an angle of −65° with respect to vertical direction of the solid image surface, are measured. Flop index value is calculated by substituting respective lightness indices in the following formula. Brilliance is evaluated according to the following standards based on the obtained values.

FI=2.69×[(L*15°)−(L*110°)^{1.11}]/(L*45°)^{1.86}

Evaluation Standards

A: Flop index value is 12.5 or more

B: Flop index value is equal to or more than 10.0 to less than 12.5

C: Flop index value is equal to or more than 5.0 to less than 10.0, a practical use available level

D: Flop index value is equal to or more than 0 to less 5.0

### Examples 1 to 63 and Comparative Examples 1 to 7

Formation of image is carried out according to the combination of toners described in Table 3 to Table 5. The results are also shown in Tables.

TABLE 3

| | Brilliant | | Yellow | | | | |
|---|---|---|---|---|---|---|---|
| | Toner | | Toner | | G′A/ | Evaluation | |
| | Case | G′A/Pa | Case | G′B/Pa | G′B | Tone | Brilliance |
| Example 1 | 2 | 1920 | 3 | 240 | 8.00 | C | A |
| Example 2 | 1 | 2050 | 3 | 240 | 8.54 | C | A |
| Example 3 | 2 | 1920 | 2 | 1080 | 1.78 | B | B |
| Example 4 | 1 | 2050 | 2 | 1080 | 1.90 | A | B |
| Example 5 | 3 | 10600 | 2 | 1080 | 9.81 | C | A |
| Example 6 | 3 | 10600 | 1 | 2110 | 5.02 | A | A |
| Example 7 | 4 | 19800 | 1 | 2110 | 9.38 | C | A |
| Example 8 | 5 | 20600 | 1 | 2110 | 9.76 | C | B |
| Example 9 | 3 | 10600 | 5 | 4290 | 2.47 | A | B |
| Example 10 | 4 | 19800 | 5 | 4290 | 4.62 | A | A |
| Example 11 | 5 | 20600 | 5 | 4290 | 4.80 | A | B |
| Comparative | 1 | 2050 | 4 | 190 | 10.79 | D | A |
| Example 1 | | | | | | | |
| Comparative | 1 | 2050 | 1 | 2110 | 0.97 | A | D |
| Example 2 | | | | | | | |
| Example 12 | 2 | 1920 | 8 | 260 | 7.38 | C | A |
| Example 13 | 1 | 2050 | 8 | 260 | 7.88 | B | A |
| Example 14 | 2 | 1920 | 9 | 340 | 5.65 | B | A |
| Example 15 | 1 | 2050 | 9 | 340 | 6.03 | B | A |
| Example 16 | 2 | 1920 | 7 | 1510 | 1.27 | A | B |
| Example 17 | 1 | 2050 | 7 | 1510 | 1.36 | B | B |
| Example 18 | 3 | 10600 | 7 | 1510 | 7.02 | B | A |
| Example 19 | 3 | 10600 | 6 | 2960 | 3.58 | A | A |
| Example 20 | 4 | 19800 | 6 | 2960 | 6.69 | B | A |
| Example 21 | 5 | 20600 | 6 | 2960 | 6.96 | B | B |
| Example 22 | 3 | 10600 | 10 | 6000 | 1.77 | A | B |
| Example 23 | 4 | 19800 | 10 | 6000 | 3.30 | A | A |
| Example 24 | 5 | 20600 | 10 | 6000 | 3.43 | A | B |
| Comparative | 4 | 19800 | 7 | 1510 | 13.11 | D | A |
| Example 3 | | | | | | | |
| Comparative | 1 | 2050 | 6 | 2960 | 0.69 | A | D |
| Example 4 | | | | | | | |

TABLE 4

| | Brilliant | | Yellow | | | | |
|---|---|---|---|---|---|---|---|
| | Toner | | Toner | | G′A/ | Evaluation | |
| | Case | G′A/Pa | Case | G′B/Pa | G′B | Tone | Brilliance |
| Example 25 | 2 | 1920 | 14 | 240 | 8.00 | C | A |
| Example 26 | 1 | 2050 | 14 | 240 | 8.54 | C | A |
| Example 27 | 2 | 1920 | 13 | 310 | 6.19 | C | A |
| Example 28 | 1 | 2050 | 13 | 310 | 6.61 | B | A |
| Example 29 | 2 | 1920 | 12 | 1400 | 1.37 | A | B |
| Example 30 | 1 | 2050 | 12 | 1400 | 1.46 | B | B |
| Example 31 | 3 | 10600 | 12 | 1400 | 7.57 | B | A |
| Example 32 | 3 | 10600 | 11 | 2750 | 3.85 | A | A |
| Example 33 | 4 | 19800 | 11 | 2750 | 7.20 | B | A |
| Example 34 | 5 | 20600 | 11 | 2750 | 7.49 | B | B |
| Example 35 | 3 | 10600 | 15 | 5580 | 1.90 | A | B |
| Example 36 | 4 | 19800 | 15 | 5580 | 3.55 | A | A |
| Example 37 | 5 | 20600 | 15 | 5580 | 3.69 | A | B |
| Comparative | 1 | 2050 | 11 | 2750 | 0.75 | A | D |
| Example 5 | | | | | | | |
| Example 38 | 2 | 1920 | 19 | 230 | 8.35 | C | A |
| Example 39 | 1 | 2050 | 19 | 230 | 8.91 | C | A |
| Example 40 | 2 | 1920 | 18 | 300 | 6.40 | C | A |
| Example 41 | 1 | 2050 | 18 | 300 | 6.83 | B | A |
| Example 42 | 2 | 1920 | 17 | 1330 | 1.44 | A | B |
| Example 43 | 1 | 2050 | 17 | 1330 | 1.54 | B | B |
| Example 44 | 3 | 10600 | 17 | 1330 | 7.97 | B | A |
| Example 45 | 3 | 10600 | 16 | 2600 | 4.08 | A | A |
| Example 46 | 4 | 19800 | 16 | 2600 | 7.62 | B | A |
| Example 47 | 5 | 20600 | 16 | 2600 | 7.92 | B | B |
| Example 48 | 3 | 10600 | 20 | 5280 | 2.01 | A | B |
| Example 49 | 4 | 19800 | 20 | 5280 | 3.75 | A | A |
| Example 50 | 5 | 20600 | 20 | 5280 | 3.90 | A | B |
| Comparative | 1 | 2050 | 16 | 2600 | 0.79 | A | D |
| Example 6 | | | | | | | |

TABLE 5

| | Brilliant | | Yellow | | | | |
|---|---|---|---|---|---|---|---|
| | Toner | | Toner | | G′A/ | Evaluation | |
| | Case | G′A/Pa | Case | G′B/Pa | G′B | Tone | Brilliance |
| Example 51 | 2 | 1920 | 24 | 230 | 8.35 | C | A |
| Example 52 | 1 | 2050 | 24 | 230 | 8.91 | C | A |
| Example 53 | 2 | 1920 | 23 | 290 | 6.62 | C | A |
| Example 54 | 1 | 2050 | 23 | 290 | 7.07 | C | A |
| Example 55 | 2 | 1920 | 22 | 1300 | 1.48 | B | B |
| Example 56 | 1 | 2050 | 22 | 1300 | 1.58 | C | B |
| Example 57 | 3 | 10600 | 22 | 1300 | 8.15 | C | A |
| Example 58 | 3 | 10600 | 21 | 2560 | 4.14 | B | A |
| Example 59 | 4 | 19800 | 21 | 2560 | 7.73 | C | A |
| Example 60 | 5 | 20600 | 21 | 2560 | 8.05 | C | B |
| Example 61 | 3 | 10600 | 25 | 5190 | 2.04 | B | B |
| Example 62 | 4 | 19800 | 25 | 5190 | 3.82 | B | A |
| Example 63 | 5 | 20600 | 25 | 5190 | 3.97 | B | B |
| Comparative | 1 | 2050 | 21 | 2560 | 0.80 | B | D |
| Example 7 | | | | | | | |

Evaluation 2

Moreover, evaluations of secondary color containing yellow toner and color toner other than yellow toner are carried out, in the same manner. At this time, the applied amount of yellow toner in the secondary color is changed to 2.5 g/cm², and the applied amount of other color toner is changed to 1.5 g/cm². The applied amount of other color toner is 4.0 g/cm². Table 6 and Table 7 show the combination of toners and the results.

TABLE 6

| | Brilliant | | Yellow | | Cyan | | | |
|---|---|---|---|---|---|---|---|---|
| | Toner | | Toner | | Toner | | Evaluation | |
| | | G′A | | G′B | G′B | G′A/ | | Bril- |
| | Case | (Pa) | Case | (Pa) | (Pa) | G′B | Tone | liance |
| Comparative | 2 | 1920 | 8 | 260 | 2020 | 0.95 | B | D |
| Example 8 | | | | | | | | |
| Example 64 | 1 | 2050 | 8 | 260 | 2020 | 1.01 | A | C |
| Comparative | 2 | 1920 | 9 | 340 | 2020 | 0.95 | B | D |
| Example 9 | | | | | | | | |
| Example 65 | 1 | 2050 | 9 | 340 | 2020 | 1.01 | A | C |
| Comparative | 2 | 1920 | 7 | 1510 | 2020 | 0.95 | B | D |
| Example 10 | | | | | | | | |
| Example 66 | 1 | 2050 | 7 | 1510 | 2020 | 1.01 | A | C |
| Example 67 | 3 | 10600 | 7 | 1510 | 2020 | 5.25 | A | B |
| Example 68 | 3 | 10600 | 6 | 2960 | 2020 | 3.58 | A | B |
| Example 69 | 4 | 19800 | 6 | 2960 | 2020 | 6.69 | B | B |
| Example 70 | 5 | 20600 | 6 | 2960 | 2020 | 6.96 | B | B |
| Example 71 | 3 | 10600 | 10 | 6000 | 2020 | 1.77 | A | C |
| Example 72 | 4 | 19800 | 10 | 6000 | 2020 | 3.30 | A | B |
| Example 73 | 5 | 20600 | 10 | 6000 | 2020 | 3.43 | A | B |
| Example 74 | 1 | 2050 | — | — | 2020 | 1.01 | A | C |
| Comparative | 2 | 1920 | — | — | 2020 | 0.95 | B | D |
| Example 11 | | | | | | | | |
| Example 75 | 3 | 10600 | — | — | 2020 | 5.25 | A | B |
| Example 76 | 4 | 19800 | — | — | 2020 | 9.80 | C | B |
| Comparative | 5 | 20600 | — | — | 2020 | 10.20 | D | C |
| Example 12 | | | | | | | | |

TABLE 7

| | | | | | Ma- | | | |
|---|---|---|---|---|---|---|---|---|
| | Brilliant | | Yellow | | genta | | | |
| | Toner | | Toner | | Toner | | Evaluation | |
| | | G′A | | G′B | G′B | G′A/ | | Bril- |
| | Case | (Pa) | Case | (Pa) | (Pa) | G′B | Tone | liance |
| Comparative | 2 | 1920 | 8 | 260 | 2530 | 0.76 | B | D |
| Example 13 | | | | | | | | |
| Comparative | 1 | 2050 | 8 | 260 | 2530 | 0.81 | A | D |
| Example 14 | | | | | | | | |
| Comparative | 2 | 1920 | 9 | 340 | 2530 | 0.76 | B | D |
| Example 15 | | | | | | | | |
| Comparative | 1 | 2050 | 9 | 340 | 2530 | 0.81 | A | D |
| Example 16 | | | | | | | | |
| Comparative | 2 | 1920 | 7 | 1510 | 2530 | 0.76 | B | D |
| Example 17 | | | | | | | | |
| Comparative | 1 | 2050 | 7 | 1510 | 2530 | 0.81 | A | D |
| Example 18 | | | | | | | | |
| Example 77 | 3 | 10600 | 7 | 1510 | 2530 | 4.19 | A | B |
| Example 78 | 3 | 10600 | 6 | 2960 | 2530 | 3.58 | A | B |
| Example 79 | 4 | 19800 | 6 | 2960 | 2530 | 6.69 | B | B |
| Example 80 | 5 | 20600 | 6 | 2960 | 2530 | 6.96 | B | B |
| Example 81 | 3 | 10600 | 10 | 6000 | 2530 | 1.77 | A | B |
| Example 82 | 4 | 19800 | 10 | 6000 | 2530 | 3.30 | A | B |
| Example 83 | 5 | 20600 | 10 | 6000 | 2530 | 3.43 | A | B |
| Comparative | 1 | 2050 | — | — | 2530 | 0.81 | B | D |
| Example 19 | | | | | | | | |
| Comparative | 2 | 1920 | — | — | 2530 | 0.76 | C | D |
| Example 20 | | | | | | | | |
| Example 84 | 3 | 10600 | — | — | 2530 | 4.19 | B | B |
| Example 85 | 4 | 19800 | — | — | 2530 | 7.83 | C | B |
| Example 86 | 5 | 20600 | — | — | 2530 | 8.14 | C | B |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A toner set comprising:
a brilliant toner containing a brilliant pigment; and
at least one kind of color toner containing a colorant,
wherein a ratio (G′A/G′B) of G′A to G′B satisfies a relationship of 1≦G′A/G′B≦10, when a storage modulus in 120° C. of the brilliant toner is G′A and a storage modulus in 120° C. of the color toner is G′B.

2. The toner set according to claim 1,
wherein a ratio (A/B) of a reflectance A at a light-receiving angle of +30° to a reflectance B at a light-receiving angle of −30°, which are measured when a solid image is formed using the brilliant toner and the image is irradiated with incident light at an incidence angle of −45° by a variable angle photometer, is from 2 to 100.

3. The toner set according to claim 1,
wherein an average equivalent-circle diameter D of the brilliant toner is longer than an average maximum thickness C thereof.

4. The toner set according to claim 3,
wherein a ratio (C/D) of the average maximum thickness C to the average equivalent-circle diameter D is from 0.001 to 0.500.

5. The toner set according to claim 1,
wherein the number of pigment particles arranged so that an angle formed by a long axis direction in a cross section of the brilliant toner and a long axis direction of the pigment particles is in a range of from −30° to +30°, is 60% or more.

6. The toner set according to claim 1,
wherein the brilliant pigment is metallic aluminum.

7. The toner set according to claim 1,
wherein a content of the brilliant pigment in the toner is from 4% by weight to 55% by weight.

8. The toner set according to claim 1,
wherein the brilliant toner includes a binder resin, and a glass transition temperature of the binder resin is from 50° C. to 65° C.

9. The toner set according to claim 8,
wherein Mw/Mn of the binder resin is from 1.5 to 100.

10. The toner set according to claim 1,
wherein the brilliant toner includes a release agent, and a melting temperature of the release agent is from 50° C. to 100° C.

11. The toner set according to claim 1,
wherein the storage modulus G′B in 120° C. of the color toner is from 500 Pas to 3000 Pas.

12. A toner set comprising:
a brilliant toner containing a brilliant pigment; and
a yellow toner containing a yellow colorant,
wherein a ratio (G′A/G′B) of G′A to G′B satisfies a relationship of 1≦G′A/G′B≦10, when a storage modulus in 120° C. of the brilliant toner is G′A and a storage modulus in 120° C. of the yellow toner is G′B.

13. The toner set according to claim 12,
wherein a ratio (A/B) of a reflectance A at a light-receiving angle of +30° to a reflectance B at a light-receiving angle of −30°, which are measured when a solid image is formed using the brilliant toner and the image is irradiated with incident light at an incidence angle of −45° by a variable angle photometer, is from 2 to 100.

14. The toner set according to claim 12,
wherein an average equivalent-circle diameter D of the brilliant toner is longer than an average maximum thickness C thereof.

15. The toner set according to claim 14,
wherein a ratio (C/Dy of the average maximum thickness C to the average equivalent-circle diameter D is from 0.001 to 0.500.

16. The toner set according to claim 12,
wherein the number of pigment particles arranged so that an angle formed by a long axis direction in a cross section of the brilliant toner and a long axis direction of the pigment particles is in a range of from −30° to +30°, is 60% or more.

17. The toner set according to claim 12,
wherein the brilliant pigment is metallic aluminum.

18. The toner set according to claim 12,
wherein a content of the brilliant pigment in the toner is from 4% by weight to 55% by weight.

19. The toner set according to claim 12,
wherein the brilliant toner includes a binder resin, and a glass transition temperature of the binder resin is from 50° C. to 65° C.

20. The toner set according to claim 19,
wherein Mw/Mn of the binder resin is from 1.5 to 100.

21. The toner set according to claim 12,
wherein the brilliant toner includes a release agent, and a melting temperature of the release agent is from 50° C. to 100° C.

22. The toner set according to claim 12,
wherein the storage modulus G′B in 120° C. of the yellow toner is from 500 Pas to 3000 Pas.

23. An image forming apparatus comprising:
a plurality of toner image forming units which includes at least a first toner image forming unit that forms a brilliant toner image using a brilliant toner containing a brilliant pigment, and a second toner image forming unit that forms a color toner image using a color toner containing a colorant;
a transfer unit that transfers at least the brilliant toner image and the color toner image onto a recording medium so as to superimpose with each other; and
a fixing unit that fixes at least the brilliant toner image and the color toner image on the recording medium,
wherein a ratio (G′A/G′B) of G′A to G′B satisfies a relationship of 1≦G′A/G′B≦10, when a storage modulus in 120° C. of the brilliant toner is G′A and a storage modulus in 120° C. of the color toner is G′B.

24. An image forming method comprising:
forming a plurality of toner images which includes at least forming a first toner image of a brilliant toner image using a brilliant toner containing a brilliant pigment, and forming a second toner image of a color toner image using a color toner containing a colorant;
transferring at least the brilliant toner image and the color toner image onto a recording medium so as to superimpose with each other; and
fixing at least the brilliant toner image and the color toner image on the recording medium,
wherein a ratio (G′A/G′B) of G′A to G′B satisfies a relationship of 1≦G′A/G′B≦10, when a storage modulus in 120° C. of the brilliant toner is G′A and a storage modulus in 120° C. of the color toner is G′B.
